(19) United States
(12) Patent Application Publication
(10) Pub. No.: US 2009/0107807 A1
(43) Pub. Date: Apr. 30, 2009

(54) Reciprocating Floor

(76) Inventor: Rene Wegkamp, Sandton (ZA)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 12/093,283

(22) PCT Filed: Nov. 8, 2006
(86) PCT No.: PCT/IB06/54159

§ 371 Date: Jul. 31, 2008

(30) Foreign Application Priority Data
Nov. 10, 2005 (ZA) 2005/09097

(51) Int. Cl. B65G 25/06

(52) U.S. Cl. 198/750.4

(57) ABSTRACT

A reciprocating floor includes at least one drive beam operable to move in a reciprocating fashion with a plurality of floor slats (14) mounted to the drive beam. At least some of the floor slats (14) have longitudinally extending downwardly depending mounting members (208). Elongate bearing members (236) slidably support associated floor slats (14), at least some of the bearing members (236) defining a longitudinally extending locking slot or keyway (504) within which the mounting member (208) of its associated floor slat (14) is slidably received. The mounting member (208) and the locking slot or keyway (504) cooperate to inhibit upwards movement of the floor slat (14) away from its associated bearing member (236).

THIS INVENTION relates to a reciprocating floor.

Reciprocating floors are known and typically include two or three drive beams driven by a drive unit, with typically aluminium floor slats or planks or sections mounted to their associated drive beam to move in a reciprocating fashion with the drive beam. The Applicant is aware of reciprocating floors in which each floor slat is supported on a plurality of longitudinally spaced bearing blocks, typically moulded of a plastics material, with the floor slats being in the form of extruded aluminium profiles having a floor portion defining a floor surface, with downwardly depending opposed side walls and opposed longitudinally extending inwardly projecting bottom lips, the floor portion slidably resting on the spaced bearing blocks and the inwardly projecting bottom lips being caught below the bearing blocks to prevent upwards movement of the floor slats away from their associated bearing blocks. One disadvantage of this arrangement is that during installation of the floor slats, the floor slats are slid lengthwise over their associated bearing blocks and knock against the bearing blocks, sometimes dislodging a bearing block. This arrangement also allows dirt to enter between the floor slats and the bearing blocks, increasing wear of the floor slats and bearing blocks and also increasing the load on the drive unit. Another concern is that the bearing blocks are installed individually, thus requiring that approximately 800 bearing blocks or more be manually installed.

According to one aspect of the invention, there is provided a reciprocating floor which includes

at least one drive beam operable to move in a reciprocating fashion with a plurality of floor slats mounted to the drive beam, at least some of the floor slats having longitudinally extending downwardly depending mounting members; and

elongate bearing members slidably supporting associated floor slats, at least some of the bearing members defining a longitudinally extending locking slot or keyway within which the mounting member of its associated floor slat is slidably received and the mounting member and the locking slot or keyway cooperating to inhibit upwards movement of the floor slat away from its associated bearing member.

Typically, at least some of the bearing members have a length which is equal to at least about one third of the length of the floor slat, so that the bearing member slidably supports the floor slat over a substantially uninterrupted lengthwise portion of the floor slat. However, the bearing members typically leave some space below the floor slats where the floor slats are mounted to their associated drive beam, and some further space allowing the drive beams to travel in reciprocating fashion. It is to be appreciated that the drive unit may be located between ends of the floor slats, so that two bearing members per floor slat may be required. Said two bearing members however then preferably support the floor slat in an uninterrupted fashion from the drive unit area outwards along the length of the floor slat.

The bearing member may have at least two transversely spaced, longitudinally extending bearing surfaces on which its associated floor slat is slidably supported, with the locking slot being located between the transversely spaced bearing surfaces.

Typically, the mounting member is centrally located between longitudinally extending side edges of the floor slat, i.e. equidistantly spaced from the side edges, each longitudinally extending half of the floor slat thus slidably resting on a bearing surface or bearing surfaces located on one or the other side of the locking slot.

The mounting member may increase in transverse dimension in a downward direction over at least a portion thereof. In other words, the mounting member may have at least one region in which it thickens downwardly forming a key portion. The locking slot may be shaped complementary to the key portion, being narrower in an upper or neck region than lower down where the key portion is received, thereby to lock the key portion inside the locking slot and interfering with or preventing or inhibiting upwards movement of the mounting member from the locking slot, or significant sideways movement of the mounting member inside the locking slot. Sufficient clearance is however preferably provided between surfaces of the mounting member and surfaces of the locking slot to allow easy longitudinal sliding of the mounting member inside the locking slot.

The floor slats may include downwardly projecting longitudinally extending seal formations flanking the bearing member, to assist in keeping dirt from between the bearing members and the floor slats.

The bearing members may be supported on elongate support beams having longitudinally extending cavities receiving or accommodating the locking slot of an associated bearing member and the mounting member of an associated floor slat. In one embodiment of the invention, at least some of the support beams are in the form of a square U-shaped channel, with a pair of longitudinally extending, transversely outwardly projecting opposed upper lips which carry or support the bearing member. In transverse cross-section, the support beam may thus correspond to a vertical section through an inverted top hat.

The bearing members may have a pair of longitudinally extending transversely inwardly projecting opposed lips, the inwardly projecting lips of a bearing member projecting underneath the outwardly projecting lips of its associated support beam to interfere with or inhibit or prevent upwards movement of the bearing member away from its associated support beam.

The bearing members may be extruded articles, and may be of a synthetic plastics or polymeric material.

The floor slats may each comprise a floor portion slidably supported on its associated bearing member, with downwardly depending transversely spaced opposed side walls. The side walls may have a height of less than about 30 mm, e.g. preferably less than about 25 mm, more preferably less than about 22 mm, e.g. about 20 mm, which is thus shorter than the side walls of the floor slats of conventional reciprocating floors of which the inventor is aware.

Although the floor slats may have longitudinally extending inwardly projecting opposed bottom lips, e.g. to strengthen or stiffen the floor slats, these lips are not required to retain the floor slats on the bearing members and thus do not have to project so far inwardly that they are caught below the bearing members. The floor slats can advantageously thus be lighter, providing a weight and cost saving compared to conventional reciprocating floors.

According to another aspect of the invention, there is provided a method of supporting an elongate floor slat of a reciprocating floor on an elongate bearing member over which the floor slat is slidable in a longitudinal direction, the method including sliding the floor slat, which has a downwardly depending mounting member, in a longitudinal direction over the bearing member, which has or which defines a longitudinally extending locking slot or keyway, with the mounting member slidably being received in a longitudinal direction in the locking slot or keyway such that upwards movement of the mounting member is inhibited or prevented by the locking slot or keyway.

The method may include supporting the bearing member on an elongate support beam as hereinbefore described. The floor slat and bearing member may be as hereinbefore described.

The invention extends to a bearing member and to a floor slat as hereinbefore described.

Thus, according to a further aspect of the invention, there is provided a reciprocating floor bearing member configured to support a floor slat, the bearing member including an elongate body defining a longitudinally extending locking slot or keyway within which a mounting member of a floor slat is slidably receivable, the locking slot or keyway being shaped and dimensioned to inhibit upwards movement of a floor slat, that has its bearing member caught in the locking slot, away from the bearing member.

The bearing member may have at least two transversely spaced, longitudinally extending bearing surfaces on which a floor slat is slidably supportable, with the locking slot being located between the bearing surfaces.

The bearing member may also include a pair of longitudinally extending transversely inwardly projecting opposed lips below the bearing surfaces.

According to yet a further aspect of the invention, there is provided a reciprocating floor slat which includes an elongate body defining a floor surface with a downwardly depending longitudinally extending mounting member below the floor surface.

The mounting member may increase in transverse dimension in a downward direction over at least a portion thereof, forming a key portion.

The floor slat may include downwardly projecting longitudinally extending seal formations below the floor surface.

The elongate body may be of aluminium or an aluminium alloy and typically includes a floor portion defining said floor surface and downwardly depending transversely spaced opposed side walls. The mounting member may be located centrally between the side walls.

Preferably, the mounting member extends the entire length of the floor slat.

The invention will now be described, by way of example only, with reference to the accompanying diagrammatic drawings in which

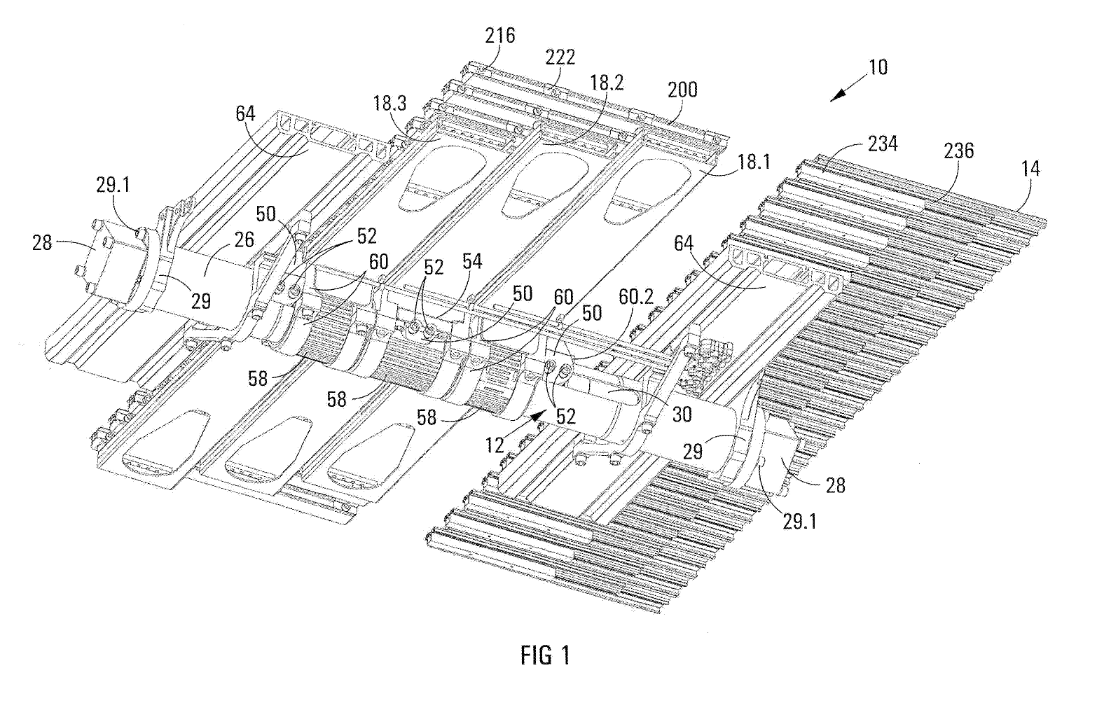

FIG. 1 shows a three-dimensional bottom view of a portion of a reciprocating floor in accordance with the invention, with portions sectioned or cut away for clarity;

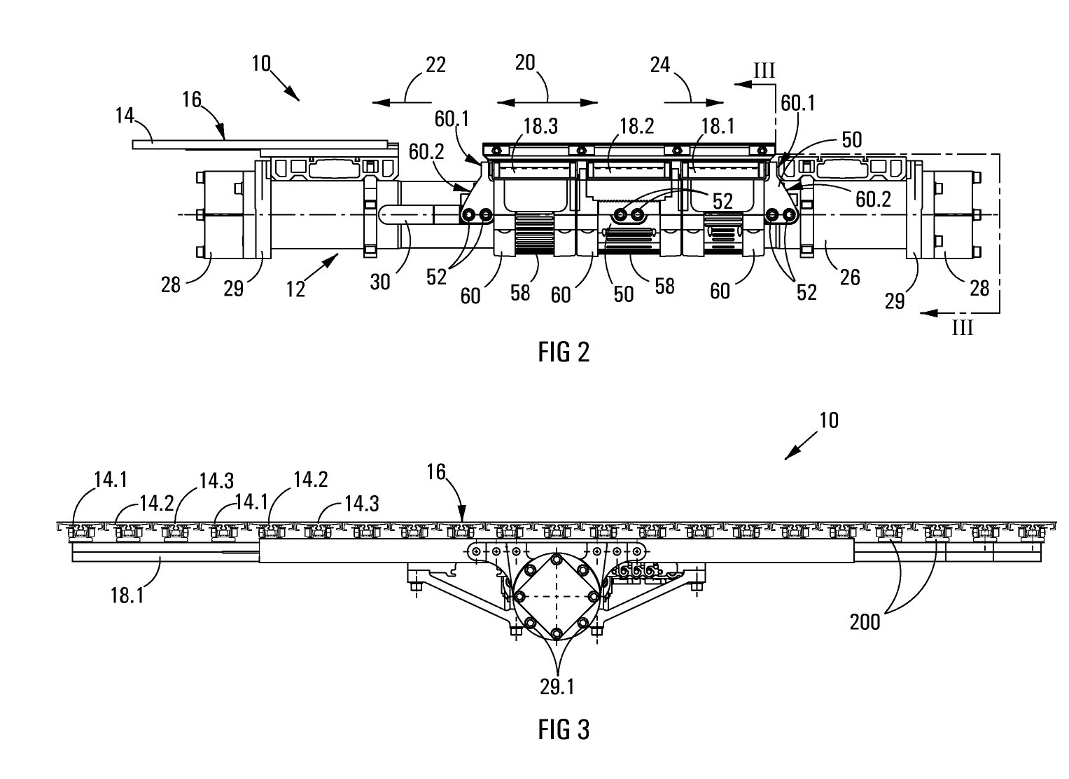

FIG. 2 shows a side elevational view of a portion of the reciprocating floor of FIG. 1, with portions sectioned or cut away for clarity;

FIG. 3 shows a transverse vertical sectioned view of the reciprocating floor of FIG. 1, taken at III-III in FIG. 2;

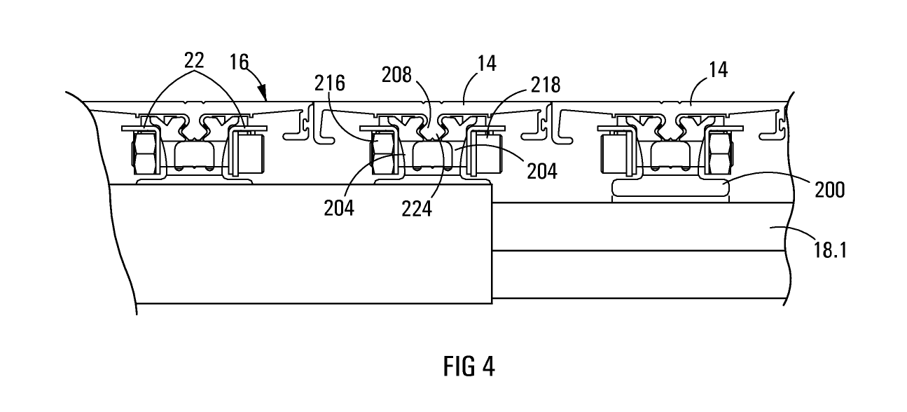

FIG. 4 shows an enlarged portion of FIG. 3;

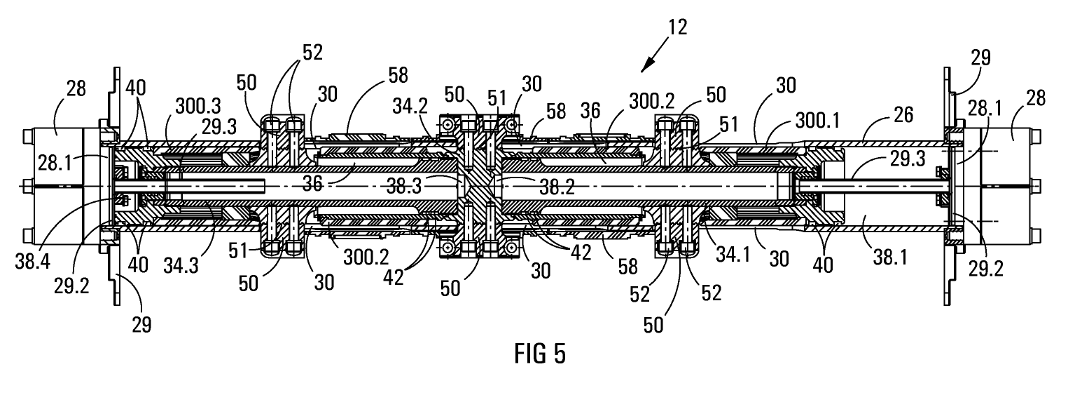

FIG. 5 shows a horizontal longitudinal section through a linear hydraulic motor of the reciprocating floor of FIG. 1;

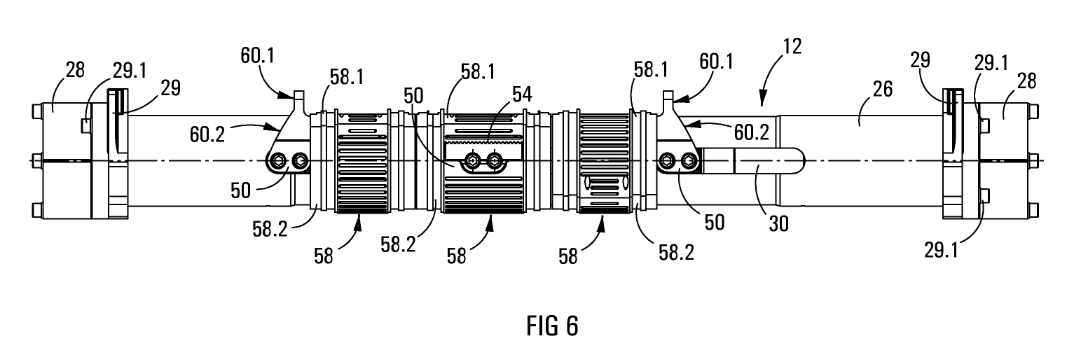

FIG. 6 shows a side elevational view of the linear hydraulic motor of FIG. 5;

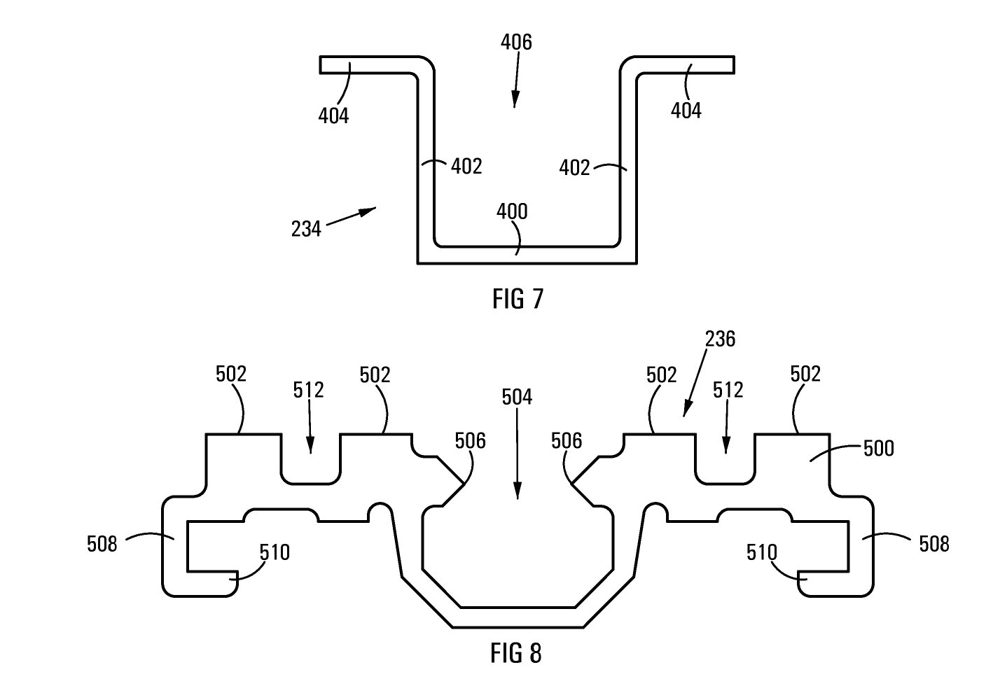

FIG. 7 shows a transverse vertical sectioned view of a support beam;

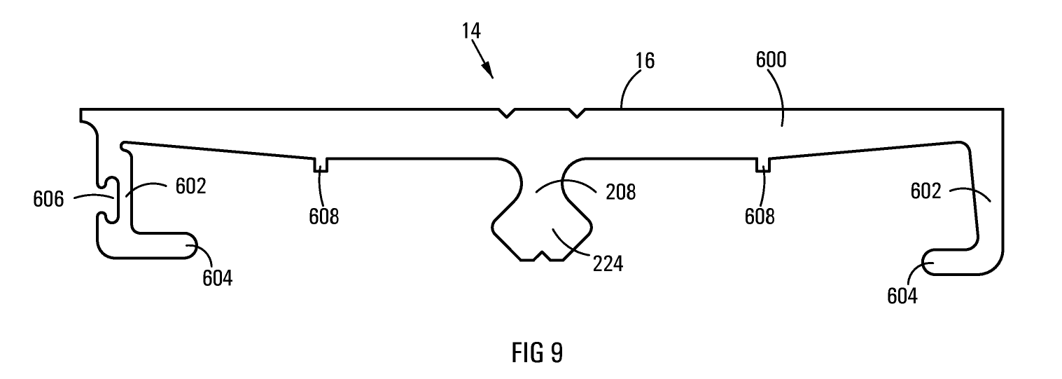

FIG. 8 shows a transverse vertical sectioned view of a bearing member;

FIG. 9 shows a transverse vertical sectioned view of a floor slat; and

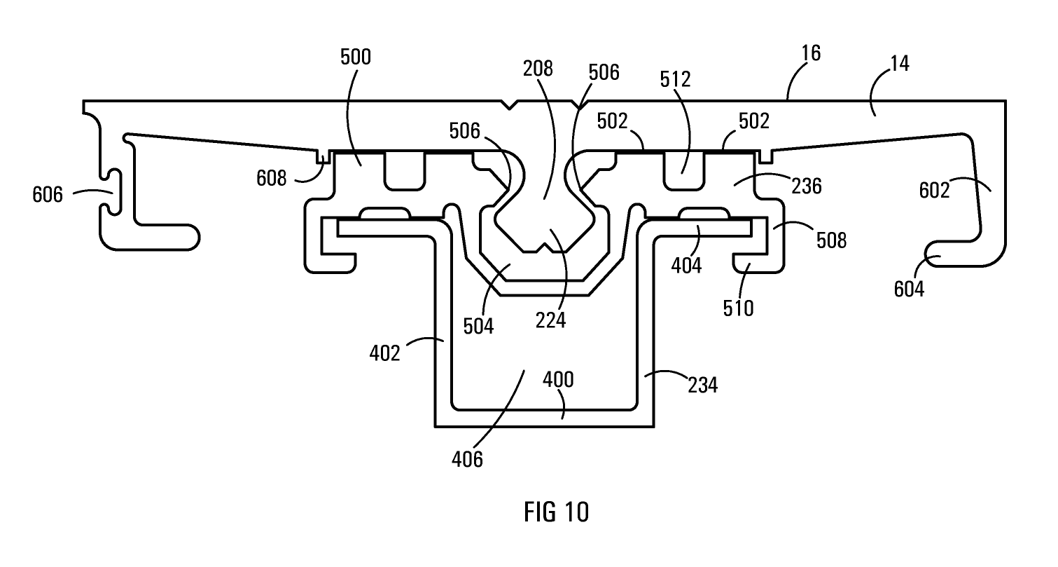

FIG. 10 shows a transverse vertical sectioned view of the floor slat of FIG. 9 being supported on the bearing member of FIG. 8 which in turn rests on the support beam of FIG. 7.

Referring to FIGS. 1 to 3, reference numeral 10 generally indicates a reciprocating floor or reciprocating floor conveyor in accordance with the invention. The reciprocating floor 10 shown is of the kind which is typically installed in a vehicle such as a heavy cargo vehicle.

The reciprocating floor 10 comprises a plurality of elongate floor members or slats 14 arranged side by side to define a floor surface 16 (see FIG. 3). The slats 14 are arranged or grouped together in three groups 14.1, 14.2 and 14.3. Thus, when starting from the left in FIG. 3, the first slat, and every third slat thereafter, belongs to the group 14.1. The second slat, and every third slat thereafter, belongs to the group 14.2 and the third slat, and every third slat thereafter, belongs to the group 14.3.

The slats of the group 14.1 are attached or mounted to a transverse drive beam 18.1, the slats of the group 14.2 are attached or mounted to a transverse drive beam 18.2 and the slats of the group 14.3 are attached or mounted to a transverse drive beam 18.3.

The reciprocating floor 10 includes a linear hydraulic motor 12 by means of which the transverse drive beams 18.1, 18.2 and 18.3, and thus the groups of slats 14.1, 14.2 and 14.3, are reciprocatingly moved backwards and forwards in a particular sequence, in the direction of the double-headed arrow 20 shown in FIG. 2. The operation of a reciprocating floor or reciprocating floor conveyor is well known to those skilled in the art, and only a very brief description of the sequence of the displacement of the groups of slats 14.1, 14.2 and 14.3 will be given.

In order to displace a load, such as a load of wood chips supported on the floor surface 16, the group of slats 14.3 is displaced longitudinally by means of the transverse drive beam 18.3 in, say, the direction of arrow 22 shown in FIG. 2 of the drawings. Thereafter, the group of slats 14.2 is displaced by means of the transverse drive beam 18.2 in the direction of arrow 22, followed by the displacement of the group of slats 14.1 by means of the transverse drive beam 18.1 in the direction of the arrow 22. As will be appreciated, with one third of the slats 14 only being displaced each time, the load supported on the floor surface 16 remains stationary. Once all three groups 14.1, 14.2 and 14.3 have been displaced in the direction of the arrow 22, all three groups 14.1, 14.2 and 14.3 are simultaneously displaced in the direction of the arrow 24 shown in FIG. 2, thus moving the entire load supported on the floor surface 16 in the direction of the arrow 24. This process is then repeated cyclically in order to move the load stepwise in the direction of the arrow 24 over the floor surface 16.

The linear hydraulic motor 12 is of the general kind described in WO 2004/067967 or, more particularly, in PCT/IB2005/003187. The motor 12 includes an elongate circular cylinder 26. Ends of the cylinder 26 are closed by means of end caps 28. The end caps 28 are bolted to the cylinder 26. Each end cap 28 comprises an end head with an integral spigot portion 28.1 (see FIG. 5) which slides into the cylinder 26 with the end head abutting against a flange 29 provided at the open ends of the cylinder 26. Threaded bolts 29.1 screw into threaded bolt holes in the flange 29 to mount the end caps 28 to the cylinder 26. An O-ring seal 29.2 is provided on the spigot portion to ensure adequate sealing between the spigot portion and the cylinder 26.

The end caps 28 include internal valve arrangements which are not shown. Advantageously, with the arrangement of the end caps 28 as shown, hydraulic fluid ports can simply extend through the end caps 28. In the embodiment of the invention shown in the drawings, it is required that two of the hydraulic fluid ports must have a tube 29.3 which extends into the cylinder 26 and then respectively through a head portion of a piston 34.3 and through a head portion of a piston 34.1, which will be described in more detail hereinafter. Each tube 29.3 is simply bolted to the spigot portion 28.1 of the end cap 28.

Six longitudinally extending apertures or slots 30 are provided in the cylinder 26. The slots 30 are arranged in three longitudinally spaced groups of two each, with the two slots 30 of each group being located on diagonally opposed sides of the cylinder 26, facing sideways in a horizontal direction. In the embodiment of the linear hydraulic motor 12 shown in the drawings, the cylinder 26 has an internal diameter of about 140 mm, a length of about 1570 mm (including the flanges 29) and slots 30 with a length of about 300 mm each. Centres of the slots 30 are spaced about 356 mm.

Three pistons 34.1, 34.2 and 34.3 are axially, reciprocatingly slidingly, located inside the cylinder 26. End portions of each piston 34.1, 34.2, 34.3 are hollow, thus advantageously reducing the weight of the pistons. Furthermore, the opposed hollow end portions of the piston 34.2 each define a bore 36 within which elongate end portions of the piston 34.1 and 34.3 are received in a sealing and sliding manner. The end portions of the pistons 34.1 and 34.3 are thus guided in the bores 36. As will thus be noted, between the cylinder 26 and the piston 34.1, 34.2 and 34.3, four varying capacity chambers 38.1, 38.2, 38.3 and 38.4 for receiving and expelling hydraulic fluid are defined. These chambers can clearly be seen in FIG. 5 of the drawings.

Annular critical hydraulic fluid seals 40 seal the piston 34.1 and 34.3 against an interior surface of the cylinder 26. Similarly, annular hydraulic fluid seals 42 seal the pistons 34.1 and 34.3 against interior surfaces of the bores 36 defined by the piston 34.2. If desired, annular bands of friction-reducing material, such as Vesconite (trade name), nylon or brass which can act as bearing surfaces for the piston 34.2, may be provided in order to facilitate axial displacement of the piston 34.2 inside the cylinder 26. Such annular bands are however not shown in the drawings.

Each piston 34.1, 34.2 and 34.3 is associated with two force transfer members or wings 50. The force transfer members 50 thus extend through associated slots 30 in use to transfer force from the pistons 34.1, 34.2 and 34.3 to which the force transfer members 50 are secured, sideways through the cylinder 26 to an associated one of the transverse drive beams 18.1, 18.2, 18.3. The force transfer members 50 are each bolted by means of two bolts 52 to its associated piston 34.1, 34.2 or 34.3. A curved contact area 51 between each force transfer member 50 and its associated piston 34.1, 34.2, 34.3 is corrugated, providing an interlocking feature to inhibit relative longitudinal displacement of the piston 34 and the force transfer member 50. This arrangement can be clearly seen in FIG. 5 of the drawings.

As can be seen in FIG. 1 of the drawings, the force transfer members 50 connecting the pistons 34.1 and 34.3 to the drive beams 18.1 and 18.3 extend upwardly to engage the drive beams 18.1 and 18.3 respectively against side walls thereof. In contrast, the force transfer members 50 connecting the piston 34.2 to the drive beam 18.2 are mounted to a bottom wall or floor of the transverse drive beam 18.2, also employing a corrugated contact arrangement as shown at 54 in FIG. 1.

Each pair of slots 30 is associated with a split collar 58 comprising an upper half 58.1 and a lower half 58.2. The upper and lower halves 58.1, 58.2 of the collars 58 encircle the cylinder 26. The four half collars 58 associated with the end apertures or slots 30 abut the four outer force transfer members 50 to travel with the outer force transfer members 50 along the length of the cylinder 26 in the directions of the double-headed arrow 20 as shown in FIG. 2 of the drawings with the force transfer members 50 limiting the longitudinal travel of the collars 58 to the length of the slot 30 minus the width of the force transfer members 50, i.e. about 190 mm. The centre collar 58 defines two apertures corresponding to the centre slots 30 through which the two centre force transfer members 50 project. Typically, one slot is provided in the upper collar half 58.1 and one slot is provided in the lower collar half 58.2. Preferably, the upper and lower collar halves 58.1, 58.2 do not meet in a horizontal plane, but rather in a plane which is arranged at an angle to the horizontal. Pairs of semi-circular brackets or split rings 60 bolt the split collars 58 to their associated drive beams 18.1, 18.2 and 18.3. Each of the transverse drive beams 18.1, 18.2, 18.3 is thus supported by an associated one of the upper collar halves 58.1. When a piston, such as the piston 30.2 is displaced axially inside the cylinder 26, its associated transverse drive beam 18.2 moves in unison with the piston 30.2, sliding on the upper collar half 58.1 over the cylinder 26. The force transfer members 50 associated with the drive beams 18.1 and 18.3 are bolted against the side walls of the drive beams 18.1 and 18.3 respectively at 60.1 (see FIG. 2), but also against outermost split rings 60 at 60.2 in FIG. 2, using bolts that are thus parallel to the longitudinal axis of the cylinder 26.

As can be clearly seen in FIG. 5 of the drawings, each piston 34.1, 34.2, 34.3 has at least one longitudinally extending portion which is of a substantially reduced diameter compared to the inside diameter of the cylinder 26. Over these portions, internal reinforcing members 300.1, 300.2 and 300.3 are located. The piston 34.2 supports two internal reinforcing members 300.2, each in the form of a circular cylindrical sleeve which is fastened to the piston 34.2 by grub screws (not shown). The reinforcing members 300.1 and 300.3 extend longitudinally from immediately behind the head portion of the pistons 34.1 and 34.3 respectively to where the force transfer members 50 are bolted to the pistons 34.1 and 34.3 and are thus caught between the head portions of the pistons and the force transfer members 50. The reinforcing members 300.2 extend longitudinally from ends of the piston 34.2 some distance towards where the force transfer members 50 are bolted to the piston 34.2. Typically, the reinforcing members 300.1, 300.2 and 300.3 are of a synthetic plastics or polymeric material such as Vesconite (trade name), which is a low kinetic or dynamic friction material.

The reinforcing members 300.1, 300.2 and 300.3 are concentric with the cylinder 26, and in particular with the internal surface thereof, and bridge the apertures or slots 30 when sliding past the slots 30. The reinforcing members 300.1, 300.2, 300.3 fit with a slight clearance of about 0.25 mm inside the cylinder 26.

The reciprocating floor conveyor 10, as illustrated, forms part of a heavy load-bearing vehicle, with the floor surface 16 defining the load-bearing surface of the vehicle. In FIG. 1 of the drawings, two transverse chassis beams or bridge beams 64 of the vehicle, from which the linear hydraulic motor 12 is suspended, are shown. Also in FIG. 1, the three drive beams 18.1, 18.2 and 18.3 are shown in positions where they are as far to the left as possible, i.e. with all three of the pistons 34.1, 34.2 and 34.3 as far to the left inside the cylinder 26 as is possible, as is shown in FIGS. 5 and 6 of the drawings. In order to displace the transverse drive beam 18.1 to the right, and thus also to displace the slats of the group of slats 14.1 to the right, a hydraulic fluid, typically a hydraulic oil, is injected into the chamber 38.2 through the tube 29.3, thus forcing the piston 34.1 to the right as far as it can go. At this time, the pistons 34.2 and 34.3 can not be displaced to the left. In order to displace the piston 34.2 to the right, hydraulic fluid is then forced into the chamber 38.3 through the other tube 29.3. At this time, the piston 34.3 can not be displaced to the left. The piston 34.3 is then displaced to the right against the piston 34.2 by injecting hydraulic fluid into the chamber 38.4 (through a port in the end cap 28 which is not shown). In order to return all three of the pistons 34.1, 34.2 and 34.3 to the starting position in which they are as far to the left as possible, hydraulic fluid is forced into the chamber 38.1 (through a port in the other end cap 28 which is also not shown), thus pushing all three pistons 34.1, 34.2, 34.3 simultaneously to the left. In this fashion, the movement sequence of the group of slats 14.1, 14.2, 14.3 is established. It is however to be appreciated that the sequence can also be reversed, with all the pistons starting at the right in FIG. 5.

Force is transferred from the linear hydraulic motor 12 to the floor slats 14 via the transverse drive beams 18. It is thus very important that the slats 14 are securely mounted to the drive beams 18. In the embodiment of the invention shown in the drawings, the slats 14 are mounted to the drive beams 18 by means of associated elongate clamp members or fingers 200. Each clamp member 200 is bolted to its associated drive beam 18 by means of seven bolts passing through predrilled bolt holes and comprises a pair of opposed side walls 204. A longitudinally extending clamping slot 206 is defined between the side walls 204 of the clamp members 200. As can be clearly seen in FIGS. 4 and 10 of the drawings, each floor slat 14 has a downwardly depending mounting member 208 which is received inside the clamping slot 206 and which is thus clamped inside the clamping slot 206. The mounting members 208 extend the entire length of the floor slats 14.

The drive beams 18 are hollow. The clamp members 200 are longitudinally spaced and transversely arranged relative to the drive beams 18. In the embodiment of the invention shown in the drawings, there are twenty-one floor slats 14 and thus twenty-one clamp members 200, with seven clamp members 200 mounted to each of the drive beams 18.1, 18.2 and 8.3 respectively.

The mounting members 208 are clamped inside the clamping slots 206 by means of nuts 216 and bolts 218. As can be clearly seen in FIG. 4 of the drawings, the bolts 218 pass below the mounting members 208. Elongate washer elements 222, which are L-shaped in transverse cross-section, are located between each bolt head and a side wall 204, and between each nut 216 and a side wall 204. The washer elements 222 bear against upper portions of the side walls 204 so that when the nuts 216 and bolts 218 are tightened, the side walls 204 move closer together in upper regions thereof, bending about lower regions thereof. The washer elements 222 located between the nuts 216 and the side walls 204 also interfere with the rotation of the nuts 216, thus acting to lock the nuts 216.

Each mounting member 208 has a thickened portion or key portion 224. The clamping slot 206 is shaped complementary to the key portion 224, being narrower in an upper region above the key portion 224, thereby to lock the key portion 224 inside the clamping slot 206 and preventing upwards movement of the mounting member 208 from the clamping slot 206.

The floor slats 14 are supported on elongate support beams 234 and elongate bearing members 236 sandwiched between the floor slats 14 and the support beams 234. Thus, both the support beams 234 and the bearing members 236 extend longitudinally underneath the floor slats 14, with the bearing members 236 providing bearing surfaces over which the floor slats 14 can slide in a reciprocating fashion as driven by their associated drive beams 18.

Each elongate support beam 234 has the appearance of an inverted top hat, when seen in transverse cross-section as shown in FIG. 7 of the drawings. Each support beam 234 has a base 400, two vertical, longitudinally extending side walls 402 and two longitudinally extending, outwardly projecting opposed lips 404. The side walls 402 and the base 400 thus define a U-shaped, open channel 406. The support beams 234 are supported on the transverse chassis beams or bridge beams 64 and further transverse chassis beams (not shown) of the vehicle within which the reciprocating floor 10 is installed. As can be seen in FIG. 1 of the drawings, the support beams 234 are bolted to the transverse chassis beams 64 (and to the further transverse chassis beams which are not shown). Two support beams 234 extend outwardly in opposite directions from the transverse chassis beam 64 to support one floor slat 14 over its entire length, apart from the area between the transverse chassis beams 64 within which the linear hydraulic motor 12 and its associated drive beams 18 are located. In FIG. 1, the support beams 234 attached to one of the transverse chassis beams 64 are shown shortened for clarity, with the support beams 234 attached to the other transverse chassis beam 64 and extending in the opposite direction not being shown at all.

Each support beam 234 is associated with an elongate bearing member 236 of substantially equal length. Referring to FIG. 8 of the drawings, each bearing member 236 comprises an elongate extruded body 500 of a synthetic plastics or polymeric material. The body 500 defines four transversely spaced bearing surfaces 502 which in use slidably support a floor slat 14. The body 500 also defines a longitudinally extending locking slot or keyway 504 which has a vertical centre plane which coincides with a vertical centre plane of the body 500. The body 500 has two inwardly projecting shoulders 506 which cause a narrowing of the locking slot or keyway 504 in an upper region thereof.

The body 500 also has two opposed, downwardly projecting short side walls 508. A pair of longitudinally extending transversely inwardly projecting opposed lips 510 are provided along bottom edges of the side walls 508.

Referring to FIG. 9 of the drawings, the mounting member 208 and the key portion 224 of the illustrated floor slat 14 are clearly shown. The floor slat 14 is an extruded aluminium profile 600 which has two downwardly depending opposed side walls 602. Longitudinally extending transversely inwardly projecting opposed short lips 604 are provided at bottom edges of the side walls 602. In one of the side walls 602, a seal-receiving slot 606 is defined.

Two downwardly projecting longitudinally extending seal formations 608 are provided on the extruded profile 600.

FIG. 10 of the drawings clearly illustrates how the support beams 234, bearing members 236 and floor slats 14 are assembled. The bearing members 236 are slid in a longitudinal direction over their associated support beams 234 so that they rest on the lips 404 of the support beams 234. The lips 510 of the bearing members 236 project inwardly far enough so that they are caught below or underneath the lips 404 of the support beams 234. Significant upwards movement of the bearing members 236 away from their associated support beams 234 is thus inhibited or prevented as a result of the interference of the lips 404 with the lips 510.

The locking slot or keyway 504 of the bearing member 236 is received inside the channel 406 defined by the support beam 234.

In order to inhibit axial or longitudinal displacement of the bearing members 236 relative to their associated support beams 234, the bearing members 236 can be riveted or bolted to the support beams 234 using a few longitudinally spaced rivets or bolts, located in longitudinally extending channels 512 defined by the body 500. Instead, or in addition, the lips 404 can be provided with transverse cuts a few centimetres away from their ends, defining end portions which can be bent upwards a few millimetres to provide blocking formations preventing longitudinal sliding of the bearing members 236 relative to the support beams 234. Naturally, this approach however requires that the bearing members 236 be slightly shorter than the support beams 234.

The floor slats 14 are slidably supported on the bearing members 236 as shown in FIG. 10 of the drawings, with a lower surface of the floor slat 14 resting on the bearing surfaces 502. The mounting member 208 of the floor slat 14, and in particular the key portion 224 thereof, is located slidably inside the locking slot or keyway 504 of the bearing member 236. The shoulders 506 prevent or inhibit upward movement of the key portion 224, thus inhibiting or preventing upwards movement of the floor slat 14 away from its associated bearing member 236. Significant sideways movement of the mounting member 208 inside the locking slot or keyway 504 is also not possible.

The seal formations 608 flank the bearing member 236 to inhibit ingress of dirt or other unwanted material between the bearing member 236 and the floor slat 14, thereby inhibiting wear and tear and preventing the building up of a slide resistance for the floor slat 14.

Elongate longitudinally extending seals (not shown) are located between adjacent floor slats 14. Portions of the seals are received in the seal formation 606 thereby to mount the seal between two floor slats 14 to one of the floor slats 14 so that it moves in unison with the floor slat 14.

The Applicant believes that the reciprocating floor 10, as illustrated, includes an improved bearing arrangement supporting the floor slats 14 in a slidable fashion, compared to the bearing arrangements of conventional reciprocating floors of which the Applicant is aware. Since an elongate bearing member is used which supports the entire portion of a floor slat extending outwardly away in one direction from the drive unit, it is not necessary to manually install hundreds of bearing blocks and, during installation of the floor slats, the problem of the floor slats bumping against individual bearing blocks is also not encountered. Furthermore, the bearing surfaces 502 are protected against ingress of dirt by the longitudinally extending seal formations 608. Advantageously, the bearing members 236, as illustrated, can be extruded and should thus be cheaper to manufacture than individual injection moulded bearing blocks. The bearing members 236 are easy to install as they are simply slid over the support beams 234. As a result of the continuous support provided by the bearing members 236 and support beams 234, the floor slats 14 can have shorter side walls 602, providing a weight and cost saving. The shorter lips 604 also provide a weight and cost saving. The continuous support underneath the floor slats 14 also ensures that the reciprocating floor 10, as illustrated, is better able to resist impact or point loads, during loading and during operation.

1. A reciprocating floor which includes
at least one drive beam operable to move in a reciprocating fashion with a plurality of floor slats mounted to the drive beam, at least some of the floor slats having longitudinally extending downwardly depending mounting members; and
elongate bearing members supporting associated floor slats slidable in a longitudinal direction, at least some of the bearing members defining a longitudinally extending locking slot or keyway within which the mounting member of its associated floor slat is longitudinally slidably received and the mounting member and the locking slot or keyway cooperating to inhibit upwards movement of the floor slat away from its associated bearing member.

2. The reciprocating floor as claimed in claim 1, in which at least some of the bearing members have a length which is equal to at least about one third of the length of the floor slat, so that the bearing member slidably supports the floor slat over a substantially uninterrupted lengthwise portion of the floor slat.

3. The reciprocating floor as claimed in claim 1, in which the bearing member has at least two transversely spaced, longitudinally extending bearing surfaces on which its associated floor slat is slidably supported, with the locking slot being located between the transversely spaced bearing surfaces.

4. The reciprocating floor as claimed in claim 1, in which the mounting member is centrally located between longitudinally extending side edges of the floor slat, i.e. equidistantly spaced from the side edges, each longitudinally extending half of the floor slat thus slidably resting on a bearing surface or bearing surfaces located on one or the other side of the locking slot.

5. The reciprocating floor as claimed in claim 1, in which the mounting member increases in transverse dimension in a downward direction over at least a portion thereof, forming a key portion, the locking slot being shaped complementary to the key portion, being narrower in an upper or neck region than lower down where the key portion is received, thereby to lock the key portion inside the locking slot and interfering with or preventing or inhibiting upwards movement of the mounting member from the locking slot, or significant sideways movement of the mounting member inside the locking slot.

6. The reciprocating floor as claimed in claim 1, in which the floor slats include downwardly projecting longitudinally extending seal formations flanking the bearing member, to assist in keeping dirt from between the bearing members and the floor slats.

7. The reciprocating floor as claimed in claim 1, in which the bearing members are supported on elongate support beams having longitudinally extending cavities receiving or accommodating the locking slot of an associated bearing member and the mounting member of an associated floor slat.

8. The reciprocating floor as claimed in claim 7, in which the bearing member has a pair of longitudinally extending transversely inwardly projecting opposed lips, the inwardly projecting lips of a bearing member projecting underneath longitudinally extending, transversely outwardly projecting opposed lips of its associated support beam to interfere with or inhibit or prevent upwards movement of the bearing member away from its associated support beam.

9. A method of supporting an elongate floor slat of a reciprocating floor on an elongate bearing member over which the floor slat is slidable in a longitudinal direction, the method including
sliding the floor slat, which has a downwardly depending mounting member, in a longitudinal direction over the bearing member, which has or which defines a longitudinally extending locking slot or keyway, with the mounting member slidably being received in a longitudinal direction in the locking slot or keyway such that upwards movement of the mounting member is inhibited or prevented by the locking slot or keyway; and supporting the bearing member on an elongate support beam having a longitudinally extending cavity to receive or accommodate the locking slot and the mounting member, the support beam extending longitudinally underneath the floor slat.

10. (canceled)

11. A reciprocating floor bearing member configured to support a floor slat, the bearing member including an elongate body defining a longitudinally extending locking slot or keyway within which a mounting member of a floor slat is slidably receivable, the locking slot or keyway being shaped and dimensioned to inhibit upwards movement of a floor slat, that has its bearing member caught in the locking slot, away from the bearing member, the bearing member having at least two transversely spaced, longitudinally extending bearing surfaces on which a floor slat is slidably supportable in a longitudinal direction, with the locking slot being located between the bearing surfaces.

12. (canceled)

13. The bearing member as claimed in claim 11, which has a pair of longitudinally extending transversely inwardly projecting opposed lips below the bearing surfaces.

14. (canceled)

15. (canceled)

16. (canceled)

17. (canceled)

18. (canceled)
